(19) United States
(12) Patent Application Publication
(10) Pub. No.: US 2024/0169364 A1
(43) Pub. Date: May 23, 2024

(54) A DEVICE, A METHOD AND A SOFTWARE PRODUCT FOR ADAPTING A REGULATED DIGITAL PLATFORM

(71) Applicant: Amplified Global LTD., London (GB)

(72) Inventors: Minesh Patel, London (GB); James Stuart, London (GB); Alastair Moore, London (GB)

(21) Appl. No.: 18/283,301

(22) PCT Filed: Mar. 24, 2022
(86) PCT No.: PCT/EP2022/057794

§ 371 Date: Sep. 21, 2023

(30) Foreign Application Priority Data
Mar. 25, 2021 (SE) 2150353-7

(51) Int. Cl. G06Q 30/018; G06F 9/445

(52) U.S. Cl. CPC G06Q 30/018; G06F 9/4451

(57) ABSTRACT

The present disclosure relates to a data processing device comprising means configured for adapting a regulated digital platform, the data processing device (120) being arranged to monitor and adapt said digital platform (110); obtain user profile data (121) indicative of interactions with said digital platform (110) associated with a user profile (111); determine a set of platform risk values (122) based on the obtained user profile data (121) and said digital platform (110), wherein said set of platform risk values (122) is indicative of at least one risk associated with said digital platform (110) for said user profile (111); and adapt said digital platform (110) for at least said user profile (111) based on the determined set of platform risk values (122), and/or determine a set of aggregate platform risk values for the digital platform (110) based on at least the determined set of platform risk values (122).

### TECHNICAL FIELD

The present disclosure relates to the usability of regulated digital platforms.

### BACKGROUND

Historically, contracts governing business transactions have been formed by legal entities, or representatives thereof, by signing a physical contract, often with all parties present. An individual client would typically prior to forming a contract with a financial institution, such as a loan or mortgage agreement with a bank, meet a representative of said institution and discuss the contract to be formed. A representative of a financial institution meeting a client in person would typically be able to assess if said client sufficiently comprehended the contract being discussed and its terms and conditions.

Legislation in many jurisdictions regulate how financial institutions should provide information to clients before a client enters into a contract with a particular financial institution, the contract being for instance a credit agreement. In some jurisdictions clients must be informed of the nature of the contract before a regulated agreement is made. In addition thereto, financial institutions often follow guidelines and best practices, such that an institution is obliged to pay due regard to the information needs of its clients and communicate information to them in a way which is clear, fair and not misleading. Typically, the formation of a contract between a client and a financial institution, wherein the client does not sufficiently comprehend the contract, is undesirable for both parties particularly in the longer term.

Today clients typically interact with their financial institutions, such as banks, via the internet instead of by meeting a representative in person. Many financial institutions and regulated institutions provide a regulated digital platform for their clients to access and utilize a plurality of services via the internet, wherein some services comprise forming a contract with said financial institution. Utilizing a digital platform may greatly facilitate client access to business transactions and services. A potential drawback that may be associated with the transition to digital platforms is an increased risk for some clients to enter into a contract without sufficiently comprehending the contract, as the checkpoint provided by the client-to-representative discussion is typically omitted.

In view of the above, there is a need for regulated digital platforms with improved usability.

### SUMMARY

It is an object of the present disclosure to provide a solution for adapting a regulated digital platform and thereby reduce any determined risk associated with use of said digital platform.

These and other objects are achieved by means of a data processing device for adapting a regulated digital platform, a method and a computer program product as defined in the appended claims.

In accordance with the present disclosure, this has been achieved by means of a data processing device comprising means configured for adapting a regulated digital platform. The data processing device being arranged to monitor and adapt said digital platform; obtain user profile data indicative of interactions with said digital platform associated with a user profile; determine a set of platform risk values based on the obtained user profile data and said digital platform, wherein said set of platform risk values is indicative of at least one risk associated with said digital platform for said user profile; and adapt said digital platform for at least said user profile based on the determined set of platform risk values, and/or determine a set of aggregate platform risk values for the digital platform based on at least the determined set of platform risk values.

In this context, it is to be understood that adapting the digital platform may comprise adapting the information provided by the digital platform, such as providing new information and/or modifying information provided by the digital platform for a specific user profile.

The present invention has the advantage of allowing the regulated digital platform to be adapted in order to minimize the risk for the user profile associated with using the digital platform on a per user profile basis. This in turn has the advantage of further enhancing the credibility by allowing the usability of the digital platform to be assessed by the determined set of aggregate platform risk values, thereby highlighting any potential risks for typical users in the digital platform as such and allowing said digital platform to be updated based on said potential risks for a typical users. This further has the advantage of allowing the digital platform owner to trace and show that due care has been taken in the interaction between users and the digital platform.

A client associated with a user profile on a regulated digital platform, wherein the digital platform is adapted by said device, may experience a personalized session as said device is configured to continuously adapt said digital platform based on obtained user profile data. The session or a set of sessions may correspond to the user profile interacting with the digital platform in order to perform the steps between forming said user profile on the digital platform to entering into a contract on said digital platform.

In an example session associated with a user profile, the device for adapting the regulated digital platform may have obtained corresponding user profile data indicative of multiple submissions of user input in an incorrect format for a type of form, whereby a set of platform risk values indicative of an elevated risks for said user profile with said type of form and similar types of forms is determined, thereafter said and similar types of forms are adapted on the digital platform for said user profile to provide additional assisting information during at least said session based on the determined set of platform risk values.

The term digital platform here refers to online platforms arranged to provide services. The term digital platform may relate to the front-end and/or the back-end of such a platform for providing services. The digital platform may for example comprise a portal for a company accessible via the internet, such as a website platform.

The term regulated digital platform refers to online platforms for performing commercial interactions between at least two parties. The regulated digital platform may for example comprise a secure banking internet services portal arranged to allow clients to perform online banking. The regulated digital platform or a representative thereof may have a legal obligation based on a transaction for a product such as a credit card, or a service such as legal or professional service. Typically, the regulated digital platform or a representative thereof may need their organisation and established processes to conform to regulations and process compliance, such as maintaining an audit trail.

The term user profile refers to a profile recognized by a digital platform, such as being a registered user profile. The user profile may for example relate to a user ID, a user name, and a user address. Typically, a client accesses a user profile on a regulated digital platform by some form of secure verification, such as utilizing a password or another authentication method, preferably a state of the art two-way authentication method. The user profile may relate to at least one account and/or at least one legal document associated with the digital platform.

Herein the term user profile is used when describing interactions with the digital platform associated with the user profile, such as the user profile logging in to the digital platform, the user profile accessing a document on the digital platform, or email communication with the digital platform. Note that the user profile as such does not perform actions, instead the interactions with the digital platform associated with said user profile are typically provided by someone or something logged in to the user profile on the digital platform. However, from the perspective of the digital platform, interactions between the user profile and the acting agent is typically not reliably available, therefore the user profile is herein described as interacting with the digital platform.

The term user profile data refers to data indicative of interactions on or with a digital platform associated with a user profile. User profile data may be indicative of both user input being directly provided to the digital platform, and the engagement with the digital platform relating to the user profile, such as the obtained answers to a questionnaire and a determined amount of time spent filling out said questionnaire respectively. It is to be understood that user profile data may be indicative of interactions associated with a user profile on a digital platform adapted by the device, such as user input from a questionnaire added to the digital platform by adapting said digital platform. User profile data may be indicative of text input on the digital platform, selected preferences on the digital platform, content saved on the digital platform, content tagged on the digital platform, a request for additional information, files uploaded to the digital platform, obtained page scrolling on the digital platform, obtained keyboard stroke patterns, obtained eye tracking, and/or other obtained behavioural biometrics.

The term session refers to a series of interactions on a digital platform associated with a user profile. The session may for example be indicative of the user profile logging in to the digital platform, performing a banking transaction on the digital platform, and logging out of the digital platform. The session may for example be indicative of the user profile activity during one day. The session may start by the user profile logging in to the digital platform, and end by the user profile logging out. The session may be defined by proceeding from a start state to a goal state.

The term set of sessions refers to a plurality of sessions for one user profile. The set of sessions may be all sessions associated with one user profile. Alternatively, the set of sessions may for example be the ten most recent sessions for one user profile. The set of sessions may also for example be all sessions for one user profile that comprise performing a specific type of interaction, such as a type of banking transaction.

The term user input refers to any provided information relating to a user profile. The user input may for example be information inserted into forms, uploaded documents, confirmations, link selections and/or requests for information. The user input may be any submitted information and/or information indicative of requesting information.

The term initial user profile data refers to user profile data obtained before and/or at the start of a session or a set of sessions. The initial user profile data may for example correspond to the information required to create a user profile on the digital platform. The initial user profile data may for example correspond to the information provided by the user profile in order to perform a new type of commercial transaction between at least two different parties. In some examples, initial user profile data comprises information indicative of interactions associated with the user profile vis-a-vis other organizations, such as a credit report.

The term user profile adaptation preferences refers to user input comprising information relating to a set of preference values. The set of preference values may for example be indicative of preferences for colour-blind mode, large font size and/or text-to-speech. Typically, preference values do not describe adapting the content of the platform, such as replacing a default text with a simplified text, instead the preference values relate to how said content of the platform is presented.

The term engagement refers to information indicative of interactions with the platform associated with a user profile, wherein engagement typically relates to information indicative of interactions excluding user input values as such, such as information indicative of the way in which a questionnaire was filled out but not the answers in the questionnaire themselves which typically falls under the term user input. The engagement may for example be indicative of the frequency of interactions with said digital platform associated with a user profile, the time spent with a particular part of content provided by the platform, the time spent providing user input, such as filling out a form, and/or any text on said digital platform that has been highlighted or copied.

The term adapting refers to providing changes or additions to the digital platform based on a set of platform risk values for one or more user profiles. Adapting a platform may for example comprise presenting a simplified text instead of a default text. Adapting a platform may for example comprise adding video and/or audio media configured to provide additional information to the digital platform. Adapting the digital platform may relate to changing a part of the platform, such as adding one video media guide, or the whole platform, such as changing text size globally. It is to be understood that adapting a digital platform may result in adapting said digital platform and/or the information it provides into the same state as it was, as in performing a step of adapting but not changing to the digital platform and/or the information it provides.

The term platform risk value refers to a determined risk associated with at least part of the platform for a user profile. The platform risk value is determined based on corresponding user profile data. The platform risk value may for example be indicative of a determined risk of obtaining incorrect and/or incomplete user input for a part of the platform, such as a questionnaire. Consequently the platform risk value may also be considered indicative of a need to adapt said platform in order to reduce said risk for one or more user profiles. Adapting the digital platform may be based on a platform risk value being above a corresponding predetermined threshold. Note that the platform risk values describe properties relating to the platform or parts thereof and not user profile behaviour as such, analogous to the difficulty ratings of slopes at a ski resort describing the slopes and not the skiers, even though the difficulty rating was determined based on how skiers interact with the slopes.

The term aggregate platform risk value refers to a determined risk associated with at least part of the platform. The aggregate platform risk value may be associated with all user profiles on the digital platform, or a subset thereof. The aggregate platform risk value may for example be indicative of the probability of a specific questionnaire question being answered incorrectly based on the sets of platform risk values of all user profiles. In some examples the aggregate platform risk values are associated with a group of user profiles, wherein the user profiles in said group are a subset of all groups that share similar interaction patterns with the digital platform.

The term risk associated with a digital platform refers to a possible undesirable event due to interaction with the digital platform associated with a user profile and/or a probability thereof. The risk value may for example be a probability scaled by a value indicative of the expected impact of said event occurring. The risk may for example be indicative of a probability for a user profile to provide incorrect user input at some part of the digital platform. The risk may for example be indicative of a probability for a user profile to spend significantly less time interacting with content provided by the platform than the expected amount of time required to read and comprehend said content, which could be indicative of a client not sufficiently comprehending the content provided.

The term legal risk refers to any risk of court action occurring whether domestic, regional or international, or the risk of any penalty resulting from non-compliance with legal requirements. Typically, a platform risk value that is a legal risk value is a value that either directly or in combination with other platform risk values defines a probability for an undesired event with legal consequences. For example a legal risk value may be the determined probability of a specific interaction with a part of the user platform resulting in non-compliance with legal requirements for signing a contract.

The term text definition refers to information describing a single word, a sentence, a paragraph, a clause, or a large body of words. The text definition for a plurality of words may for example be a glossary for said words. In some examples the text definition for a word is provided as a “pop up” upon interaction with said word, such as highlighting, clicking or mousing over text.

The term key terms and concepts refers to critical words with particular legal significance for the corresponding part of the digital platform. The key terms and concepts may for example in the context of forming a loan contract be the terms Amortization, Down payment, and Interest.

The term text simplification refers to providing a simplified version of a single word, a sentence, a paragraph, a clause, or a large body of words. Providing text simplification may for example comprise to in a text replace “principal” with “amount of debt remaining on the loan”.

The term video and/or audio media refers to a video media, audio media or multimedia. The media may for example be media describing key terms and concepts. The media may for example describe a recommended way in which to interact with the digital platform, such as a guide.

In some examples, the data processing device is arranged to obtain user profile data for a plurality of user profiles, determine the set of platform risk values for said plurality of user profiles, and determine the set of aggregate platform risk values for the digital platform based on said plurality of sets of platform risk values. In some of these examples, the data processing device is arranged to adapt said digital platform for at least the user profile further based on said set of aggregate platform risk values.

This has the advantage of allowing adapting of the digital platform for a user profile based on the set of platform risk values for the user profile, the corresponding set of aggregate platform risk values, or a combination thereof. This further has the advantage of allowing different parts of the digital platform to be adapted based on varying weightings between the set of platform risk values associated with a user profile and the corresponding set of aggregate platform risk values, such as using a weighting for a new part of the digital platform that is different from a weighting for an older part. This may allow a user profile to be grouped for the purpose of determining a set of aggregate platform risk values with user profiles exhibiting similar patterns of interacting with the platform, such as user profiles frequently providing faulty user input, thereby allowing the digital platform to be adapted for said user profile based on the sessions of user profiles associated to the same set of aggregate platform risk values.

In some examples, the data processing device is arranged to determine the set of aggregate platform risk values for the digital platform based on at least the obtained user profile data.

This has the advantage of allowing the set of aggregate platform risk values to be determined based on a typically greater amount of information relating to the user profile. This further allows the interactions with specific parts of the digital platform of a plurality of user profiles to be utilized to determine at least one corresponding aggregate platform risk value.

In some examples the data processing device is arranged to determine the set of platform risk values based on the obtained user profile data utilizing an artificial neural network trained with a training set of user profile data and corresponding platform risk values. In some examples data processing device is arranged to determine the set of aggregated platform risk values based on at least said determined set of aggregated platform risk values utilizing an artificial neural network trained with a training set of platform risk values and corresponding aggregated platform risk values.

This has the advantage of allowing patterns of interaction to be identified and assigned a platform risk value. This further has the advantage of allowing the obtained user profile data, the determined set of platform risk values and the determined set of aggregated platform risk values to be utilized to improve said artificial neural networks with various machine learning methods. This further has the advantage of allowing an improved ability to handle uncertainty in event impacts and the ability to deal with nebulous goals.

In some examples the data processing device is arranged to obtain user profile adaptation preferences by adapting said digital platform, and adapt said digital platform based on any obtained user profile adaptation preferences. An example of obtaining user profile adaptation preferences by adapting said digital platform is to provide a questionnaire on the digital platform with questions relating to the user profile adaptation preferences. In some of these examples the data processing device is arranged to, upon no user profile adaptation preferences existing for the corresponding user profile and part of the platform, obtain user profile adaptation preferences by adapting said digital platform.

This has the advantage of allowing the data processing device to request user input associated with the user profile, thereby allowing specific user profile data to be obtained. This further has the advantage of allowing at least some user profile data to be obtained for the user profile at an initial stage of the session and/or the series of sessions.

It is to be understood that “obtain user profile adaptation preferences by adapting said digital platform” relates to adapting a part of said digital platform, such as adapting the platform to present a questionnaire relating to preferences, and monitoring any interaction between the user profile and said adapted part of said digital platform, whereby user profile adaptation preferences may be obtained.

The present disclosure further relates to a method for adapting a regulated digital platform. The method comprises
providing a digital platform;
obtaining user profile data indicative of interactions with said digital platform associated with a user profile;
determining a set of platform risk values based on the obtained user profile data, wherein said set of platform risk values is indicative of at least one risk associated with said digital platform for said user profile; and
adapting said digital platform for at least the user profile based on the determined set of platform risk values, and/or determining a set of aggregate platform risk values for the digital platform based on at least the determined set of platform risk values.

The present disclosure further relates to a computer program product comprising a non-transitory computer-readable storage medium having thereon a computer program comprising program instructions, the computer program being loadable into a processor and configured to cause the processor to perform the method for adapting a regulated digital platform.

### BRIEF DESCRIPTION OF THE DRAWINGS

Throughout the figures, same reference numerals refer to same parts, concepts, and/or elements. Consequently, what will be said regarding a reference numeral in one figure applies equally well to the same reference numeral in other figures unless not explicitly stated otherwise.

FIG. 1 shows schematically a digital platform and a data processing device for adapting said platform.

FIG. 2a-b schematically depict the process of adapting a digital platform with a data processing device.

FIG. 3 depicts schematically a method for adapting a digital platform.

FIG. 4 depicts schematically a data processing unit comprising a computer program product.

### DETAILED DESCRIPTION

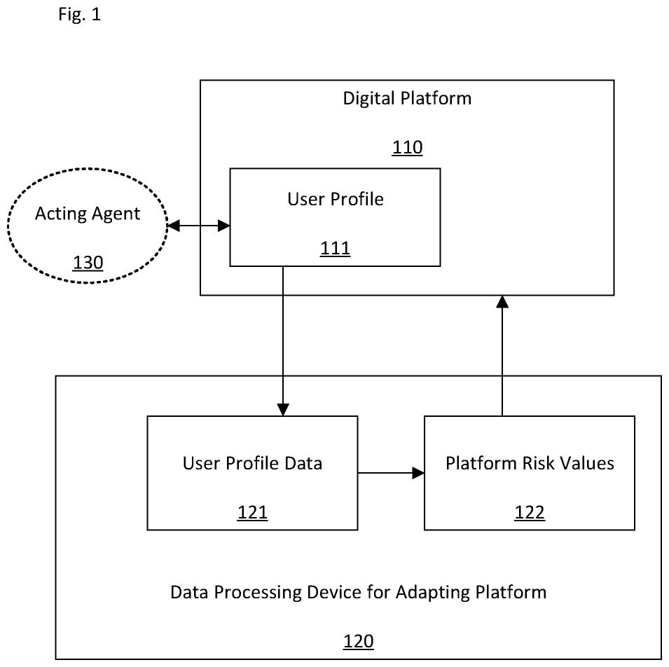

FIG. 1 shows schematically a digital platform 110 and a data processing device 120 for adapting said platform 110. The data processing device 120 being arranged to communicate with the digital platform 110. The data processing device 120 being arranged to
monitor and adapt said digital platform 110;
obtain user profile data 121 indicative of interactions with said digital platform 110 associated with a user profile 111;
determine a set of platform risk values 122 based on the obtained user profile data 121, wherein said set of platform risk values 122 is indicative of at least one risk associated with said digital platform 110 for said user profile 111; and
adapt said digital platform 110 for at least said user profile 111 based on the determined set of platform risk values 122, and/or determine a set of aggregate platform risk values for the digital platform 110 based on at least the determined set of platform risk values 122.

In the example according to FIG. 1, the data processing device 120 is depicted as an external device monitoring and adapting the digital platform 110. In some examples the data processing device 120 is integrated into and/or comprised in the digital platform 110. In some examples the data processing device 120 is partially integrated into and/or comprised in the digital platform 110.

In the example according to FIG. 1, an acting agent 130, such as a client or a user, interacts with the digital platform 110 via a corresponding user profile 111 during a session. The data processing device 120 being arranged to monitor said interactions and determine corresponding user profile data 121 based on said monitored actions. In this example the user profile data 121 is updated continuously and upon updating the profile data 121 the set of platform risk values 122 is determined, thereafter the acting agent 130 accessing the digital platform 110 via the user profile 111 is presented with the digital platform 110 adapted by the data processing device 120 based on said determined set of platform risk values 122.

In the example according to FIG. 1, the user profile data 121 comprises information indicative of a previous session of interactions on the digital platform 110 associated with the user profile 111. The set of determined platform risk values 122 being based on user profile data 121 corresponding to at least the previous session and the current session. In this example a determined platform risk value 122 is indicative of an interaction risk with a legal text being above a threshold value, whereby the data processing device 120 hereafter adapts parts of the digital platform 110 comprising such and similar legal texts by providing text definitions for said legal texts, such as a glossary, for the user profile 111.

Determining a platform risk value 122 based on user profile data 121 may be performed in a multitude of ways. Selecting the whole or a subset of the user profile data 121 for determining a platform risk value 122 may be selected based on a time period, a type of interaction with the digital platform 110, a minimum session duration, and/or a frequency of performing a type of interaction with the digital platform 110. The value of a platform risk value 122 may be a discrete value based on the corresponding user profile data 121 and a set of criteria, such as a platform risk value 122 being set to 1 if said user profile data 121 is indicative of an abnormal interaction with a part of the digital platform 110 corresponding to the platform risk value 122, otherwise set to 0.

In some examples the value of a platform risk value 122 is determined based on corresponding user profile data 121 processed through an artificial neural network. In some of these examples each output node value of said artificial neural network determines a platform risk value 122. The use of artificial neural network allows non-trivial interaction patterns indicative of the user profile 111 “learning the digital platform” to be extracted from the user profile data 121 and used to determine the platform risk values 122, whereby the platform risk values 122 may represent concepts of understanding or interest.

In some examples at least one determined platform risk value 122 may be based on a determined probability of one or more events occurring and a corresponding value indicative of the impact of said one or more events occurring. In some of these examples the least one determined platform risk value 122 corresponds to the probability of events multiplied by a severity weighting of the corresponding events.

In some examples at least one determined platform risk value 122 is a legal risk value indicative of at least one legal risk associated with said digital platform 110.

In some examples the set of platform risk values 122 is a set of legal risk values.

The term “legal risk” relates to any risk of court action occurring whether domestic, regional or international, or the risk of any penalty resulting from non-compliance with legal requirements. Typically, a platform risk value 122 that is a legal risk value is a value that either directly or in combination with other platform risk values 122 defines a probability for an undesired event with legal consequences. For example a legal risk value may be the determined probability of a specific interaction with a part of the user platform resulting in non-compliance with legal requirements for signing a contract. Typically, determining a platform risk value 122 that is a legal risk value is based on a set of criteria for the corresponding legal risk.

In some examples the data processing device 120 is arranged to determine a set of platform risk values 122 based on the obtained user profile data 121 and said digital platform 110.

In some examples the data processing device 120 is arranged to determine a platform risk value 122 based on the user profile data 121, wherein the user profile data 121 is indicative of a frequency of interaction with said digital platform 110 associated with the user profile 111, and wherein determining the platform risk values 122 is based on said frequency of interaction with said digital platform 110. In some of these examples said frequency of interaction corresponds the platform risk values 122 being determined, such as the frequency of filling out a questionnaire on the digital platform 110 and the platform risk values 122 relating to said questionnaire.

In some examples the data processing device 120 is arranged to determine platform risk values 122 utilizing natural language processing (NLP) model against a risk model, wherein said risk model is based on predetermined interaction data, risk data, and outcome data. In some of these examples utilizing the natural language processing model and the risk model comprises utilizing and training an artificial neural network.

In some examples the user profile data 121 may comprise initial user profile data. In some of these examples the user profile data 121 is determined at the start of a session based on the initial user profile data, wherein the initial user profile data is indicative of interactions associated with the user profile 111 occurring before and/or at the start of the session. In some examples the starting state of a session for a user profile 111 is adapted based on initial user profile data comprised in the user profile data 121. The use of a priori information allows the digital platform 110 to be adapted for the user profile 111 even before the user profile's 111 first interaction with the digital platform 110, such as providing different starting adaptation for the first session of a user profile 111 associated with an 18 year user and a user profile 111 associated with a 35 year old user.

In some examples the data processing device 120 is arranged to obtain user profile data 121 comprising at least one previously determined set of aggregate platform risk values. In some examples the data processing device 120 is arranged to obtain user profile data 121 comprising initial user profile data comprising any previously determined set of aggregate platform risk values matching at least one criteria based on the other user profile data 121. As an example, upon creation of a user profile 111 initial user profile data may be determined, wherein the initial user profile data comprise any sets of aggregate platform risk values for sub-sets of user profiles 111 on the digital platform 110 that share characteristics with said created user profile 111, such as being newly created user profiles 111.

In some examples the user profile data 121 comprises at least one previously determined platform risk value 122 and/or aggregate platform risk value. In some embodiments the data processing device 120 is arranged to store determined sets of platform risk values 122, and is arranged to determine the set of platform risk values 120 based on stored sets of platform risk values 120. In some embodiments the data processing device 120 is arranged to store determined sets of aggregate platform risk values, and is arranged to determine the set of platform risk values 122 based on stored sets of aggregate platform risk values.

In some examples the data processing device 120 is arranged to monitor and adapt said digital platform 110, wherein monitor and adapt comprises adapting a part of said digital platform 110, such as adapting the platform to present a questionnaire, and monitoring any interaction between the user profile 111 and said adapted part of said digital platform 110. For example, the data processing device 120 may passively monitor the interaction between the user profile 111 and digital platform 110, alternatively the data processing device 120 may actively adapt the digital platform 110 to allow for new interactions between the user profile 111 and the adapted digital platform 110 in order to obtain additional information.

In some examples the data processing device 120 adapts the digital platform 110 based on the determined platform risk values 122 via a set of criteria, such as a set of thresholds comprising threshold values for each adaptable part of the digital platform. In some of these examples, the set of criteria corresponds to a legal risk.

In some examples the determined platform risk values 122 represent the adapting to be done of the digital platform 110. It is to be understood that for some examples of the data processing device 120 a set of determined platform risk values 122 would not need to be explicitly determined, instead some data processing devices 120 may directly adapt the digital platform 110 for a corresponding user profile based on the user profile data 121. However, during the process of converting user profile data 121 to a set of instructions for adapting a digital platform 110 it appears unavoidable to at some point generate information corresponding to a set of determined platform risk values 122 in the broadest sense of the term.

In some examples the data processing device 120 is arranged to obtain user profile data 121 for a plurality of user profiles 111, determine the sets of platform risk values 122 for said plurality of user profiles 111, and determine the set of aggregate platform risk values for the digital platform 110 based on said plurality of sets of platform risk values 122. In some of these examples the data processing device 120 is arranged to adapt the digital platform 120 for at least one of the plurality of user profiles 111 based the set of aggregate platform risk values. In some of these examples the data processing device 120 is arranged to adapt the digital platform 120 for the plurality of user profiles 111 based the set of aggregate platform risk values.

In some examples the set of aggregate platform risk values are based on the sets of platform risk values 122 corresponding to at least 3 user profiles 111. In some of these examples the sets of platform risk values 122 corresponding to at least 5, at least 10, or at least 30 user profiles 111. The value of an aggregate platform risk value may be based on a determined probability of one or more events occurring and a corresponding value indicative of the impact of said one or more events occurring.

The plurality of user profiles 111 corresponding to set of aggregate platform risk values may be all the user profiles on the digital platform 110. The plurality of user profiles 111 corresponding to set of aggregate platform risk values may be a subset of all user profiles on the digital platform 110 which user profile data shares one or more property, such as being indicative of frequently providing incorrect information in a type of interaction with the digital platform 110. The plurality of user profiles 111 corresponding to set of aggregate platform risk values may be selected based on the total amount of time of each user profile 111 has interacted with the digital platform 110.

It is to be understood that possible complexity of determined platform risk values 122 and aggregated platform risk values, and thereby the possible options in adapting the digital platform 110, may be reliant on the user profile data 121. Over time a data processing device 120 that obtains significantly more user profile data 121 than it had at an early stage may be able to utilize methods for determining platform risk values 122 and aggregated platform risk values that would not have been viable for the user profile data 121 from said early stage. In some examples the data processing device 120 is arranged to select based on the user profile data 121, a procedure for determining the platform risk values 122; and determine platform risk values 122 based user profile data 121 utilizing said selected procedure.

In some examples the data processing device 120 is arranged to continuously monitor interactions on the digital platform 110. In some examples the data processing device 120 is arranged to continuously adapt the digital platform 110. In these examples the data processing device 120 may monitor a plurality of user profiles 111 over time and determine numeric, decision-theoretic measurements of quality and learning performance associated with the digital platform 110 and said user profiles 111.

In some examples the data processing device 120 is arranged to monitor interactions on the digital platform 110 associated with the user profile 111, wherein monitor interactions and obtain user profile data 121 indicative of said interactions comprises obtaining user profile data 121 indicative of keystrokes, pointer movements, user presence, eye movements and/or other biometric information associated with the user profile 111 if available. Obtain user profile data 121 may for each part of the digital platform 110 be indicative of dwell time, liked, watched, listened, opened, downloaded, copied and/or other measureable interactions with said part.

In some examples interactions with the digital platform 110 comprises electronic communication, such as email, and/or physical mail. In some of these examples the data processing device 120 is arranged to adapt the provided emails and/or letters sent to an address associated with a user profile.

In some examples the data processing device is arranged to adapting the regulated digital platform, wherein the regulated digital platform provides user profiles 111 or any associate thereof with banking transactions, loan agreements, leases, sales contracts, licensing agreements, and/or employment contracts.

In some examples user profile data 121 may further comprise information indicative of interactions associated with the user profile 111 vis-a-vis other organizations, such as a credit report. In some examples user profile data 121 may further comprise information indicative of behavioural patterns associated with the user profile 111 obtained from an external source, such as public data sources. In some examples user profile data 121 may further comprise information indicative of an educational level associated with the user profile 111, such as an education level, or a demographic classification based on socio-economic status, such as the NRS social grade used in the United Kingdom.

The digital platform 110 may be adapted by the data processing device 120 based on the set of platform risk values 122 in a multitude of ways. Adapting an example digital platform 110 arranged to provide information in the form of a webpage with text and questionnaires for a user profile may comprise simplifying text on the webpage, providing a glossary explaining key terms and concepts on the webpage, and/or providing video/audio media explaining how to use the webpage. The selected type(s) of adapting by the data processing device 120 is typically based on the set of platform risk values 122, however, in practice all types of adapting may not be available for all parts of the digital platform 110. Adapting the digital platform 110 may be performed upon determining a platform risk value, and/or may be performed upon a corresponding user profile accessing a part of the digital platform 110 corresponding to said platform risk value.

In some examples adapting the digital platform 110 comprises simplifying text, wherein providing simplified text comprises ranking each word and/or sentences for comprehension difficulty and replacing words and/or sentences based on the rank and the set of platform risk values 122.

In some examples, adapting the digital platform 110 comprises providing a description of key terms and concepts in the corresponding part of the digital platform 110. In some of these examples the data processing device 120 selects the key terms and concepts in the part of the digital platform 110 based on a set of criteria, such as sequential, weighted, duration, and/or frequency.

It is to be understood that adapting the digital platform 110 is not limited to the described examples. In some examples wherein the digital platform 110 provides a website comprising multiple web pages, adapting the digital platform 110 may comprise providing different web pages based on the set of platform risk values 122. In some of these examples adapting the digital platform 110 comprises providing different websites based on the set of platform risk values 122.

In some examples the data processing device 120 is arranged to obtain user profile data 121 by adapting said digital platform 110. In some of these examples the data processing device 120 adapts the digital platform 110 to provide to the user profile 111 with a questionnaire configured to obtain user input, whereby obtained user profile data 121 is obtained based on the interaction of the user profile 111 with said questionnaire.

In some examples the data processing device 120 monitors interactions on, obtains user profile data 121 from, and adapts the digital platform 110 in a continuous manner. Such a continuous mode may be suitable for an open-ended example session on a digital platform 110 wherein the user profiles 111 is free to interact with the digital platform 110 in a large number of ways at any given point during the session. At the opposite spectrum a restricted example session on a digital platform 110 may be indicative of a journey that is linear or corresponds to a flowchart, such as a linear multi-step process to enter into a contract on the digital platform 110. In some examples the data processing device 120 adapts the digital platform 110 at discrete checkpoints based on a determined journey corresponding to the session of the user profile 111.

In some examples the data processing device 120 is arranged to obtain user profile adaptation preferences and adapt said digital platform 110 based on any obtained user profile adaptation preferences. In some of these examples said user profile adaptation preferences are obtained by adapting said digital platform 110. In some of these examples the obtained user profile adaptation preferences are utilized to determine the set of platform risk values 122. Obtained user profile adaptation preferences may in some situations be used directly without determining the set of platform risk values 122, such as large text size. Obtained user profile adaptation preferences relates to a preferred format for the information provided by the digital platform 110 and typically do not represent a risk as such, however, the user profile adaptation preferences may be combined with the user profile data to determine the set of platform risk values 122. Obtained user profile adaptation preferences may be indicative of providing a specific type of adaptation for at least one type of content on the digital platform 110, such as if available providing a glossary when providing a legal text.

In some examples the data processing device 120 is arranged to obtain user profile adaptation preferences and adapt said digital platform 110 based on the set of platform risk values and any obtained user profile adaptation preferences.

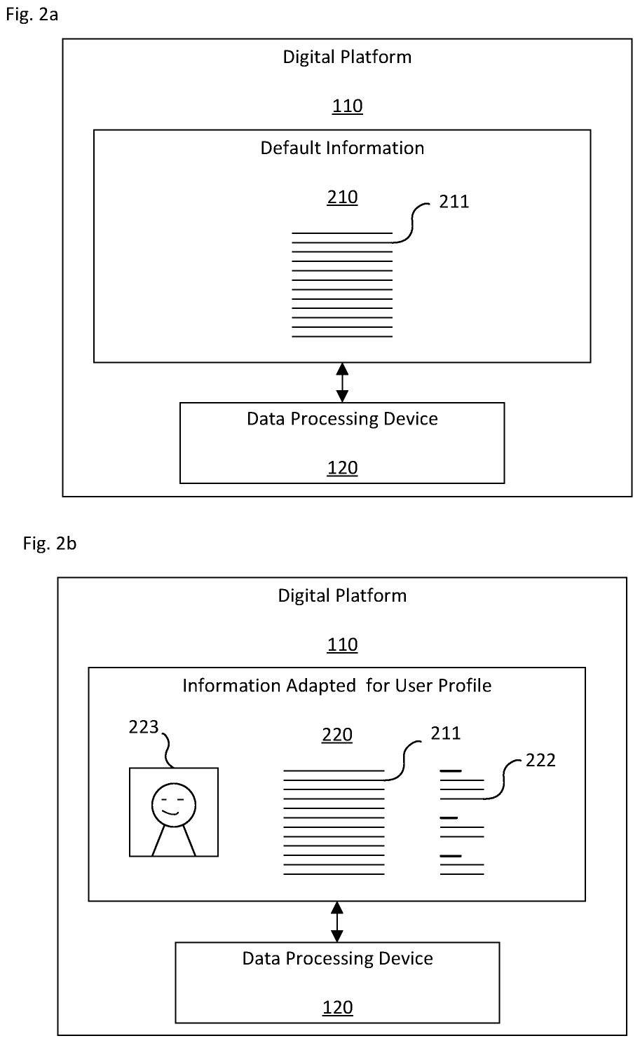

FIG. 2a-b schematically depict the process of adapting a digital platform with a data processing device. In this comparison example the digital platform may provide default information indicative of information not adapted for any specific user profile(s). FIG. 2a visualizes such default information, and FIG. 2b visualizes the default information adapted for the user profile.

FIG. 2a shows an example digital platform 110 with an integrated data processing device 120 for adapting said digital platform 110. The digital platform comprises default information 210 associated with a part of the digital platform 110, wherein the default information 210 comprises a legal text 211. In this example a first user profile accessing said part of the digital platform 110 corresponding to the default information 210, and having no risk values associated with said part of the digital platform 110, would obtain the legal text 211 as is.

FIG. 2b shows an example digital platform 110 with an integrated data processing device 120 for adapting said digital platform 110. The digital platform comprises default information 210 associated with a part of the digital platform 110, wherein the default information 210 comprises a legal text 211. In this example a second user profile accessing said part of the digital platform 110 corresponding to the default information 210, while having risk values associated with said part of the digital platform 110, results in the data processing device 120 adapting the default information 210 by providing a glossary 222 and media 223 explaining the legal text 211. In this example the glossary 222 and media 223 were provided because the second user profile's set of risk values fulfilled at least one corresponding criteria, such as being above a threshold. In this example the data processing device 120 is arranged to adapt the legal text 211 by providing text simplification, however, the second user profile's set of risk values did not fulfil the criteria for text simplification.

The data processing device may adapt the default information 210 for the second user profile by providing external links to additional information.

In some examples the integrated data processing device 120 is arranged to adapt a part of the digital platform 110, wherein the adapted part of the digital platform 110 leads a user profile from a start state selected based on corresponding set of platform risk values to subsequent states selected the corresponding set of platform risk values. In one of these examples all possible paths for a user profile from a starting state forms a branching structure of states, wherein at each node a user profile is lead along one path based on the corresponding set of platform risk values, wherein a user profile being led along one path of a branching structure of states is equivalent to adapting the digital platform for the user profile.

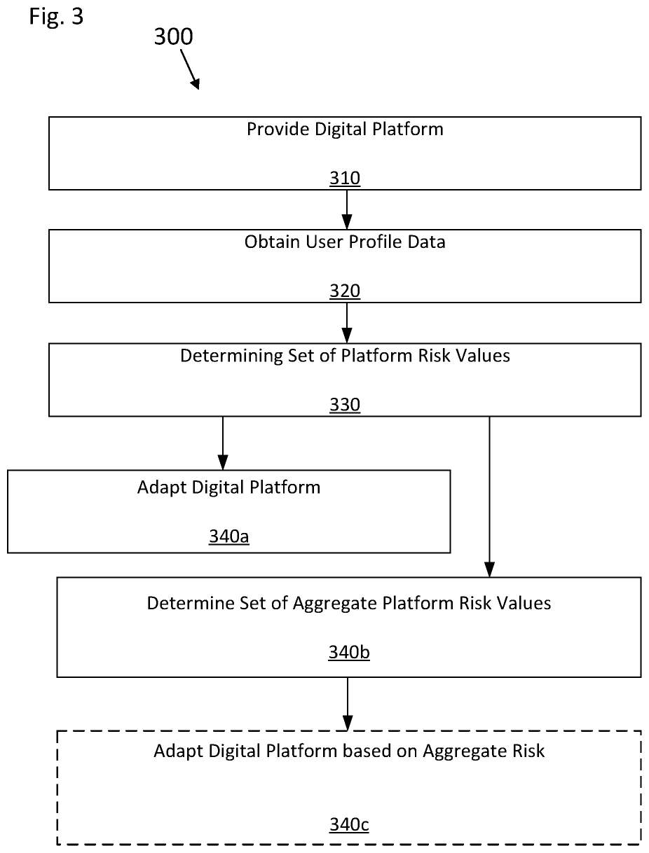

FIG. 3 depicts schematically a method for adapting a digital platform.

A method for adapting a regulated digital platform, the method 300 comprises
providing 310 a digital platform;
obtaining 320 user profile data indicative of interactions with said digital platform associated with a user profile;
determining 330 a set of platform risk values based on the obtained user profile data, wherein said set of platform risk values is indicative of at least one risk associated with said digital platform for said user profile; and
adapting 340a said digital platform for at least the user profile based on the determined set of platform risk values, and/or determining 340b a set of aggregate platform risk values for the digital platform based on at least the determined set of platform risk values.

In some examples the method comprises determining 340b the set of aggregate platform risk values for the digital platform further based on a plurality of sets of platform risk values each corresponding to a different user profile, and adapting 340c said digital platform for at least the user profile based on the set of aggregate platform risk values.

In some examples determining 340b the set of aggregate platform risk values results in adapting 340c the digital platform for a plurality of user profiles based on said set of aggregate platform risk values.

In some examples upon determining 340b the set of aggregate platform risk values, said digital platform is adapted 340c for the user profile based on said determined set of aggregate platform risk values.

In some examples upon determining 340b the set of aggregate platform risk values, said digital platform is adapted 340c for all user profiles on the digital platform based on said determined set of aggregate platform risk values. In some of these examples the digital platform is adapted 340c to provide the same version for all user profiles based on the set of aggregate platform risk values, these examples may not provide information tailored for specific user profile but may be suitable to discover default information for the digital platform to utilize.

In some examples the set of platform risk values comprises a legal risk value indicative of at least one legal risk associated with said digital platform.

In some examples determining 330 the set of platform risk values, wherein the set of platform risk values is a set of legal risk values.

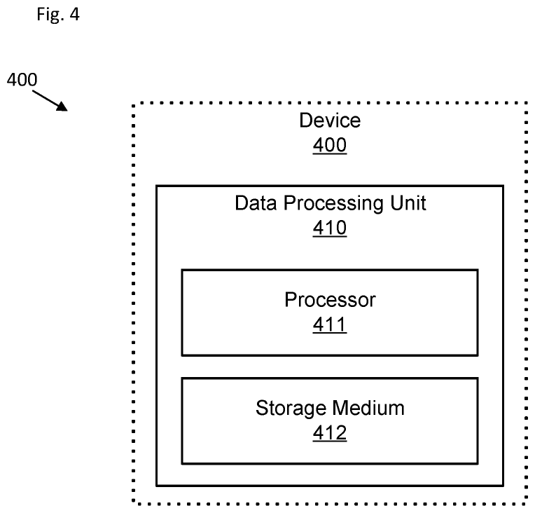

FIG. 4 depicts schematically a data processing unit 410 comprising a computer program product for adapting a regulated digital platform. FIG. 4 depicts a data processing unit 410 comprising a computer program product comprising a non-transitory computer-readable storage medium 412. The non-transitory computer-readable storage medium 412 having thereon a computer program comprising program instructions. The computer program is loadable into a data processing unit 510 and is configured to cause a processor 411 to carry out the method for adapting a regulated digital platform in accordance with the description of FIG. 3.

The data processing unit 410 may be comprised in a device 400.

The data processing unit 410 may be comprised in a digital platform.

Returning to FIG. 1 and FIG. 3 a use example will be described. Example scenario describes a client creating a user profile 111 and applying for a credit card on a regulated digital platform 110, wherein the regulated digital platform 110 is a website platform of a bank configured to be monitored and adapted by a data processing device 120. In this example the data processing device 120 is arranged to adapt the digital platform 110 to provide legal text with simplified language and provide supporting multimedia content.

In the example scenario the client fills out personal details on digital platform 110 to create a user profile 111. The interactions performed in order to provided personal details corresponds to the initial user profile data for said user profile 111. The data processing device 120 determines user profile data 121 for said user profile based 111 on the initial user profile data.

The client accesses the digital platform 110 via the user profile 111 by logging in, thereby starting a session for the user profile 111. In this example scenario the user profile 111 is initially guided through the signing of Terms and Conditions, wherein the data processing device is arranged to adapts parts of the digital platform 110 to help the client understand terms and conditions. The type adaptation and the level of adaptation provided is based on a determined platform risk value 122 for the user profile 111 determined based one the user profile data 121. In this example the determined platform risk value 122 fulfilled the criteria for adapting the part of the digital platform 110 corresponding to signing of Terms and Conditions by provide a glossary important terms in said part.

The user profile performs a number of actions on the digital platform 110, among them the user profile attempts to submit information in an incorrect format on multiple occasions in a part of the digital platform 110 related to applying for a credit card. The data processing device continuously updates the user profile data based on the monitored interactions between the digital platform 110 and the user profile. The data processing device is arranged to upon updating the user profile data 121 update the set of platform risk values 122 for the user profile 111 based on said user profile data 121.

In this example scenario the data processing device updates the platform risk values for the user profile to be indicative of an increased risk of incorrect information being submitted. The platform risk values are indicative of risk(s) of the interaction with the whole or a part of the digital platform 110 associated with the user profile, such as the website platform obtaining incorrect or incomplete information in a type of queries.

Upon the user profile 111 accessing the part of the digital platform 110 related to applying for a credit card the data processing device 120 provides an adapted digital platform 110, wherein the adapted digital platform 110 now contains a simplified text describing how to apply for a credit card, and video media explaining the process of applying for a credit card.

In this example scenario the data processing device 120 utilizes an artificial neural network trained with a training set of user profile data and corresponding platform risk values.

Said user profile 111 keeps accessing the digital platform 110, continuously updating the set of platform risk values 122 and adapting the digital platform 110 accordingly. Upon said user profile 111 successfully and repeatedly interacting with parts of the digital platform 110 similar to the part related to applying for a credit card, the resulting set of platform risk values 122 changes to no longer indicate that simplified text should be provided for said part(s).

Then the user profile 111 provides incorrect information in the part of the digital platform 110 related to applying for a credit card, whereby the resulting set of platform risk values 122 are updated. In this example the data processing device 120 is arranged to weigh the interaction of providing incorrect information significantly lower for the user profile 111 experienced with said part, compared to the weighting used when the user profile 111 was newly created.

In this example the user profile 111 has applied for a credit card on the digital platform 110, whereby the digital platform 110 sends an email to an address associated with said user profile 111, wherein said email has been adapted by the data processing device 120 based on the determined platform risk values 122.

What is claimed is:

1. A data processing device comprising means configured for adapting a regulated digital platform, the data processing device being arranged to:
monitor and adapt said digital platform;
obtain user profile data indicative of interactions with said digital platform associated with a user profile;
determine a set of platform risk values based on the obtained user profile data and said digital platform wherein said set of platform risk values is indicative of at least one risk associated with said digital platform for said user profile; and
adapt said digital platform for at least said user profile based on the determined set of platform risk values, and/or determine a set of aggregate platform risk values for the digital platform based on at least the determined set of platform risk values.

2. The data processing device according to claim 1, arranged to obtain user profile data for a plurality of user profiles, determine the sets of platform risk values for said plurality of user profiles, and determine the set of aggregate platform risk values for the digital platform based on said plurality of sets of platform risk values.

3. The data processing device according to claim 1, wherein the device is arranged to monitor text highlighting and/or text copying in the digital platform associated with the user profile.

4. The data processing device according to claim 1, wherein the device is arranged to monitor time spent interacting with a part of content provided by said digital platform, wherein the interaction with the part of content is associated with the user profile.

5. The data processing device according to claim 1, wherein the device is arranged to obtain user profile data indicative of a determined frequency of interaction with said digital platform associated with the user profile, and wherein determining the set of platform risk values is based on said frequency of interaction with said digital platform.

6. The data processing device according to claim 1, wherein the device is arranged to obtain user profile data by adapting said digital platform, such as providing a questionnaire configured to obtain user input.

7. The data processing device according to claim 1, wherein the device is arranged to determine the set of platform risk values based on the obtained user profile data utilizing an artificial neural network trained with a training set of user profile data and corresponding platform risk values.

8. The data processing device according to claim 1, wherein the device is arranged to adapt said digital platform by providing text simplification.

9. The data processing device according to claim 1, wherein the device is arranged to adapt said digital platform by providing text definitions for key terms and concepts comprised in the adapted part of the digital platform.

10. The data processing device according to claim 1, wherein the device is arranged to adapt said digital platform by providing video and/or audio media describing key terms and concepts comprised in the adapted part of the digital platform.

11. The data processing device according to claim 1, wherein the device is arranged to:
obtain user profile adaptation preferences by adapting said digital platform; and
adapt said digital platform based on any obtained user profile adaptation preferences.

12. A method for adapting a regulated digital platform, the method comprises:
providing a digital platform;
obtaining user profile data indicative of interactions with said digital platform associated with a user profile;
determining a set of platform risk values based on the obtained user profile data, wherein said set of platform risk values is indicative of at least one risk associated with said digital platform for said user profile; and—adapting said digital platform for at least the user profile based on the determined set of platform risk values, and/or determining a set of aggregate platform risk values for the digital platform based on at least the determined set of platform risk values.

13. A computer program product comprising a non-transitory computer-readable storage medium having thereon a computer program comprising program instructions, the computer program being loadable into a processor and configured to cause the processor to perform the method for adapting a regulated digital platform according to claim 12.
